(19) United States
(12) Patent Application Publication
(10) Pub. No.: US 2015/0373714 A1
(43) Pub. Date: Dec. 24, 2015

(54) METHOD FOR PROVIDING COMMUNICATION SERVICE AND ELECTRONIC DEVICE THEREOF

(71) Applicant: Samsung Electronics Co., Ltd., Gyeonggi-do (KR)

(72) Inventor: Min-Chull PAIK, Gyeonggi-do (KR)

(21) Appl. No.: 14/734,280

(22) Filed: Jun. 9, 2015

(30) Foreign Application Priority Data
Jun. 18, 2014 (KR) 10-2014-0074296

(51) Int. Cl. H04W 72/04; H04W 88/06

(52) U.S. Cl. CPC H04W 72/0453; H04W 88/06

(57) ABSTRACT

An example embodiment of the present disclosure relates to an apparatus and method for providing a communication service in an electronic device in communication with a 1^{st} and 2^{nd} communication network. The method may be executable on the apparatus to process signals for different frequency bands of the 2^{nd} communication network through a plurality of Radio Frequency Integrated chips (RFICs), identify whether a signal of the 1^{st} communication network is received through a 1^{st} antenna in a 1^{st} RFIC of the plurality of RFICs when detecting the signal of the 1^{st} communication network, and processing a signal of the 2^{nd} communication network received through the 2^{nd} communication network, wherein the 1^{st} antenna transmits/receives a signal utilizing at least one of the 1^{st} communication network or the 2^{nd} communication network, and wherein the 2^{nd} antenna receives a signal utilizing at least one of the 1^{st} communication network or the 2^{nd} communication network.

### CLAIM OF PRIORITY

This application claims the benefit under 35 U.S.C. §119(a) of a Korean patent application filed in the Korean Intellectual Property Office on Jun. 18, 2014 and assigned Serial No. 10-2014-0074296, the entire disclosure of which is hereby incorporated by reference.

### TECHNICAL FIELD

An example embodiment of the present disclosure relates to an apparatus and method for providing a communication service in an electronic device.

### BACKGROUND

Wireless communication systems have developed into a broadband wireless communication system which provides a high-speed and high-quality packet data service, without being limited to conventionally provided voice services.

With the development of wireless communication systems, an electronic device which supports wireless communication may provide a plurality of communication services using a plurality of communication networks. For example, the electronic device may provide a voice communication service and a data service through a Circuit Switching (CS) network (e.g., a Code Division Multiple Access (CDMA) network) which provides the voice communication service and a Packet Switching (PS) network (e.g., a Long Term Evolution (LTE) network) which provides the data service.

### SUMMARY

When a plurality of communication services are provided in an electronic device, the electronic device may include a communication module (e.g., a Radio Frequency Integrated Chip “RFIC” or an antenna) for each communication system. Accordingly, a size of the electronic may necessarily increase, or a power consumption level may increase, due to requirements of space and power for the plurality of communication modules. Therefore, there is a need in the art to address these issues.

An example embodiment of the present disclosure provides an apparatus and method for providing a Long Term Evolution (LTE) service using a carrier aggregation scheme in an electronic device.

An example embodiment of the present disclosure provides an apparatus and method for receiving a control signal (e.g., a paging signal) for a Circuit Switching (CS) network during an LTE service using a carrier aggregation scheme in an electronic device.

In one aspect of the present disclosure, an electronic device is disclosed, including a 1^{st} antenna configured to transmit/receive a first signal using at least one of a 1^{st} communication network or a 2^{nd} communication network, a 2^{nd} antenna configured to receive a second signal using at least one of the 1^{st} communication network or the 2^{nd} communication network, a 1^{st} Front End Unit (FEU) configured to split the first signal into a plurality of frequency band signals for the 1^{st} communication network or the 2^{nd} communication network, a 2^{nd} FEU configured to split the second signal into the plurality of frequency band signals for the 1^{st} communication network or the 2^{nd} communication network, a 1^{st} Radio Frequency Integrated Chip (RFIC) configured to process a 1^{st} frequency band signal of the first plurality of frequency band signals and the second plurality of frequency band signals provided from the 1^{st} FEU or the 2^{nd} FEU for the 2^{nd} communication network, and a 2^{nd} RFIC configured to process a 2^{nd} frequency band signal of the first plurality of frequency band signals and the second plurality of frequency band signals provided from the Pt FEU or the 2^{nd} FEU for the 2^{nd} communication network, wherein, when a 3rd frequency band signal is identified for the Pt communication network, the 1^{st} RFIC is configured to process the 3rd frequency band signal of the plurality of frequency band signals provided from the 1^{st} FEU and process the 1^{st} frequency band signal provided from the 2^{nd} FEU.

In another aspect of this disclosure, a method of operating an electronic device in communication with a 1^{st} and 2^{nd} communication network is disclosed, the method including processing signals for different frequency bands of the 2^{nd} communication network through a plurality of Radio Frequency Integrated chips (RFICs), and identifying whether a signal of the 1^{st} communication network is received through a 1^{st} antenna by a 1st RFIC of the plurality of RFICs when detecting the signal of the 1^{st} communication network, and processing a signal of the 2^{nd} communication network received through the 2^{nd} communication network, wherein the 1^{st} antenna transmits/receives a signal utilizing at least one of the 1^{st} communication network or the 2^{nd} communication network, and wherein the 2^{nd} antenna receives a signal utilizing at least one of the 1^{st} communication network or the 2^{nd} communication network.

In another aspect of this disclosure, a non-transitory computer readable recording medium storing program instructions, the program instructions executable by a processor of an electronic device to process signals for different frequency bands of a 2^{nd} communication network through a plurality of Radio Frequency Integrated Chips (RFICs) in the electronic device, the electronic device comprising a 1^{st} antenna for transmitting/receiving a signal utilizing at least one of a 1^{st} communication network or the 2^{nd} communication network, and a 2^{nd} antenna for receiving a signal utilizing at least one of the 1^{st} communication network and the 2^{nd} communication network, and when the signal is received through the 1^{st} communication network, identify whether the signal of the 1^{st} communication network is received through the 1^{st} antenna by the 1^{st} RFIC of the plurality of RFICs, and process a signal of the 2^{nd} communication network received through the 2^{nd} antenna.

### BRIEF DESCRIPTION OF THE DRAWINGS

The example embodiments of the present disclosure will be more apparent from the following detailed description taken in conjunction with the accompanying drawings, in which:

FIG. 1 illustrates a block diagram of an electronic device according to various example embodiments of the present disclosure;

FIG. 2 illustrates a block diagram of a 1^{st} Front-End-Unit (FEU) in detail according to an example embodiment of the present disclosure;

FIG. 3 illustrates a block diagram of a 1^{st} FEU in detail according to an example embodiment of the present disclosure;

FIG. 4 illustrates a block diagram of a 1^{st} FEU in detail according to an example embodiment of the present disclosure;

FIG. 5 illustrates a block diagram of a 2^{nd} FEU in detail according to an example embodiment of the present disclosure;

FIG. 6 illustrates an example process of receiving a control signal of a Circuit Switching (CS) network during a Long Term Evolution (LTE) service in an electronic device according to an example embodiment of the present disclosure;

FIG. 7 illustrates an example process of receiving a control signal of a CS network during an LTE service in an electronic device according to an example embodiment of the present disclosure;

FIG. 8 illustrates an example process of switching a communication service in an electronic device according to an example embodiment of the present disclosure; and

FIG. 9 illustrates a block diagram of an electronic device according to various example embodiments of the present disclosure.

### DETAILED DESCRIPTION

Hereinafter, various example embodiments of the present disclosure are described with reference to the accompanying drawings. While the example embodiments of the present disclosure are susceptible to various modifications and alternative forms, a specific embodiment thereof has been shown by way of example in the drawings and will herein be described in detail. It should be understood, however, that it is not intended to limit the various example embodiments of the present disclosure to the particular form disclosed, but, on the contrary, the various example embodiments of the present disclosure are to cover all modifications and/or equivalents and alternatives falling within the various example embodiments of the present disclosure as defined by the appended claims. Like reference numerals denote like constitutional elements throughout the drawings.

The expression “include” or “may include” used in the various example embodiments of the present disclosure is intended to indicate a presence of a corresponding function, operation, or constitutional element disclosed herein, and it is not intended to limit a presence of one or more functions, operations, or constitutional elements. In addition, in the various example embodiments of the present disclosure, the term “include” or “have” is intended to indicate that characteristics, numbers, steps, operations, constitutional elements, and components disclosed in the specification or combinations thereof exist, and thus should be understood that there are additional possibilities of one or more other characteristics, numbers, steps, operations, constitutional elements, components or combinations thereof.

In the various example embodiments of the present disclosure, an expression “or” includes any and all combinations of words enumerated together. For example, “A or B” may include A or B, or may include both A and B.

In the various example embodiments of the present disclosure, although expressions such as “1^{st}”, “2^{nd}”, “first”, and “second” may be used to express various constitutional elements of the present disclosure, it is not intended to limit the corresponding constitutional elements. For example, the above expressions are not intended to limit an order or an importance of the corresponding constitutional elements. The above expressions may be used to distinguish one constitutional element from another constitutional element. For example, a 1^{st} user device and a 2^{nd} user device are both user devices, and indicate different user devices. For example, a 1^{st} constitutional element may be termed a 2^{nd} constitutional element, and similarly, the 2^{nd} constitutional element may be termed the 1^{st} constitutional element without departing from the scope of the present disclosure.

When a constitutional element is mentioned as being “connected” to or “accessing” another constitutional element, this may mean that it is directly connected to or accessing the other constitutional element, but it is to be understood that there are no intervening constitutional elements present. On the other hand, when a constitutional element is mentioned as being “directly connected” to or “directly accessing” another constitutional element, it is to be understood that there are no intervening constitutional elements present.

The terminology used in the various example embodiments of the present disclosure is for the purpose of describing particular example embodiments only and is not intended to be limiting of the present disclosure. A singular expression includes a plural expression unless there is a contextually distinctive difference therebetween.

Unless otherwise defined, all terms (including technical and scientific terms) used herein have the same meaning as commonly understood by those ordinarily skilled in the art to which the present disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

An electronic device according to an example embodiment of the present disclosure may be a device including a communication function. For example, the electronic device may include at least one of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), a MPEG-1 Audio Layer 3 (MP3) player, a mobile medical device, a camera, or a wearable device (e.g., a Head-Mounted-Device (HMD) such as electronic glasses, electronic clothes, an electronic bracelet, an electronic necklace, an electronic appcessory, an electronic tattoo, or a smart watch).

According to certain example embodiments, the electronic device may be a smart home appliance having a communication function. For example, the smart home appliance may include at least one of a TeleVision (TV), a Digital Video Disk (DVD) player, an audio, a refrigerator, an air conditioner, a cleaner, an oven, a microwave oven, a washing machine, an air purifier, a set-top box, a TV box (e.g., Samsung HomeSync™ Apple TV™, or Google TV™), a game console, an electronic dictionary, an electronic key, a camcorder, or an electronic picture frame.

According to certain example embodiments, the electronic device may include at least one of various medical devices (e.g., Magnetic Resonance Angiography (MRA), Magnetic Resonance Imaging (MRI), Computed Tomography (CT), imaging equipment, ultrasonic instrument, etc.), a navigation device, a Global Positioning System (GPS) receiver, an Event Data Recorder (EDR), a Flight Data Recorder (FDR), a car infotainment device, an electronic equipment for ship (e.g., a vessel navigation device, a gyro compass, etc.), avionics, a security device, or an industrial or domestic robot.

According to certain example embodiments, the electronic device may include at least one of a furniture or a part of building/constructions including a communication function, an electronic board, an electronic signature receiving device, a projector, or various measurement machines (e.g., water supply, electricity, gas, propagation measurement machine, etc.). The electronic device according to the present disclosure may be one or more combinations of the aforementioned various devices. In addition, it is apparent those ordinarily skilled in the art that the electronic device according to the present disclosure is not limited to the aforementioned devices.

Hereinafter, an electronic device according to various example embodiments will be described with reference to the accompanying drawings. The term ‘user’ used in the various example embodiments may refer to a person who uses the electronic device or a device (e.g., an Artificial Intelligence “AI” electronic device) which uses the electronic device.

Hereinafter, an example embodiment of the present disclosure describes a technique for providing a Long Term Evolution (LTE) system using a carrier aggregation scheme in an electronic device.

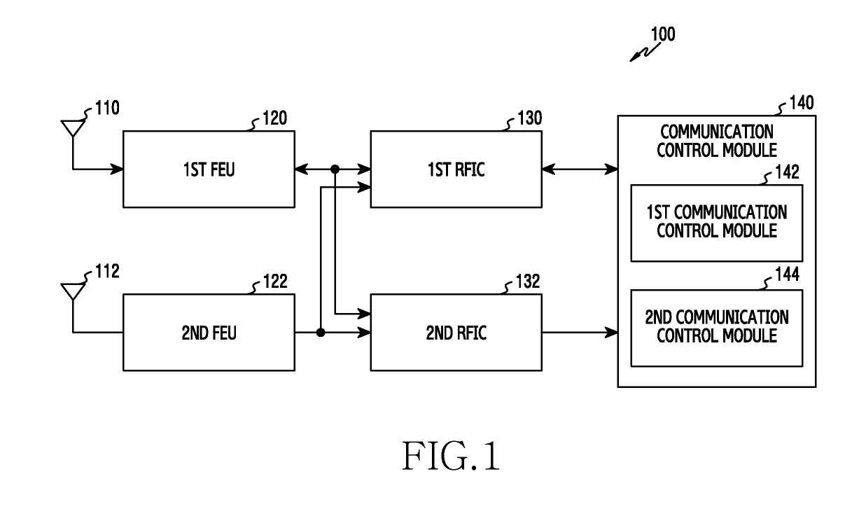

FIG. 1 illustrates a block diagram of an electronic device according to various example embodiments of the present disclosure.

Referring to FIG. 1, an electronic device 100 may include a main antenna 110, a sub antenna 112, a 1^{st} Front-End-Unit (FEU) 120, a 2^{nd} FEU 122, a 1^{st} Radio Frequency Integrated Chip (RFIC) 130, a 2^{nd} RFIC 132, and a communication control module 140.

The main antenna 110 may be operatively coupled to the electronic device 100, and transmit/receive a signal for at least one communication service (e.g., a voice call service or a data service) provided by the electronic device 100. According to one example embodiment, the main antenna 110 may simultaneously or sequentially transmit or receive at least one of a signal of a plurality of frequency bands (e.g., a Band Class “BC” 0 band, a BC1 band) for a 1^{st} communication network or a signal of a plurality of frequency bands (e.g., a Band “B” 4 band, a B13 band) for a 2^{nd} communication network.

The sub antenna 112 may be operatively coupled to the electronic device 100 and receive a signal for at least one communication service (e.g., a voice call service or a data service) provided by the electronic device 100. According to one example embodiment, the sub antenna 112 may simultaneously or sequentially receive at least one of the signal of the plurality of frequency bands (e.g., the BC0 band, the BC1 band) for the 1^{st} communication network or the signal of the plurality of frequency bands (e.g., the B4 band, the B13 band) for the 2^{nd} communication network.

According to one example embodiment, at least one of the main antenna 110 or the sub antenna 112 operatively coupled to the electronic device 100 may include an antenna included in the electronic device 100 or an antenna included in an external device which communicates with the electronic device 100.

According to one example embodiment, the 1^{st} communication network may be a Circuit Switching (CS) network utilizing a transmission technique such as Code Division Multiple Access (CDMA), Wideband CDMA (WCDMA), Time Division-Synchronous CDMA (TD-SCDMA), Evolution-Data Optimized (EV-DO), Global System for Mobile communications (GSM), or the like. The 2^{nd} communication network may be a Packet Switching (PS) network utilizing a transmission technique such as Long Term Evolution (LTE), mobile WiMAX, or the like. On the contrary, the 1^{st} communication network may be the PS network, and the 2^{nd} communication network may be the CS network. Hereinafter, for convenience of explanation, it is described in an example embodiment of the present disclosure that the Pt communication network is the CS network, and the 2^{nd} communication network is the PS network. For example, the 1^{st} communication network may be the CS network which uses the CDMA transmission technique, and the 2^{nd} communication network may be the PS network, which uses the LTE transmission technique.

The 1^{st} FEU 120 may split a signal received through the main antenna 110 and routes (or transmits) the split signal through at least one RFIC (e.g., the 1^{st} RFIC 130 or the 2^{nd} RFIC 132). According to one example embodiment, the 1^{st} FEU 120 may split the signal received through the main antenna 110 into a signal of a high frequency band (e.g., the BC1 band of the 1^{st} communication network, the B4 band of the 2^{nd} communication network) or a signal of a low frequency band (e.g., the BC0 band of the 1^{st} communication network, the B13 band of the 2^{nd} communication network). The 1^{st} FEU 120 may split the signal of the low frequency band into a signal of the 1^{st} communication network (e.g., a signal of the BC0 band) and a signal of the 2^{nd} communication network (e.g., a signal of the B13 band) and route the signals to the 1^{st} RFIC 130. The 1^{st} FEU 120 may split the signal of the high frequency band into a signal of the 1^{st} communication network (e.g., a signal of the BC1 band) and a signal of the 2^{nd} communication network (e.g., a signal of the B4 band) and route the signals to the 2^{nd} RFIC 132.

The 1^{st} FEU 120 may route to the main antenna 110 a signal for at least one communication service (e.g., a voice call service or a data service), provided from the 1^{st} RFIC 130. According to one example embodiment, the 1^{st} FEU 120 may simultaneously or sequentially route to the main antenna 110 the signal provided from the 1^{st} RFIC 130. Herein, the signal is at least one of a signal of a plurality of frequency bands (e.g., the BC0 band, the BC1 band) for the 1^{st} communication network or a signal of a plurality of frequency bands (e.g., the B4 band, the B13 band) for the 2^{nd} communication network.

The 2^{nd} FEU 122 may split a signal received through the sub antenna 112 and route the signal to at least one RFIC (e.g., the 1^{st} RFIC 130 or the 2^{nd} RFIC 132). According to one example embodiment, the 2^{nd} FEU 122 may split the signal received through the sub antenna 112 into a signal having a high frequency band (e.g., the BC1 band of the 1^{st} communication network, the B4 band of the 2^{nd} communication network) or a signal having a low frequency band (e.g., the BC0 band of the 1^{st} communication network, the B13 band of the 2^{nd} communication network). The 2^{nd} FEU 122 may split the signal of the low frequency band into a signal of the 1^{st} communication network (e.g., a signal of the BC0 band) and a signal of the 2^{nd} communication network (e.g., a signal of the B13 band) and route the signals to the 1^{st} RFIC 130. The 2^{nd} FEU 122 may split the signal of the high frequency band into a signal of the Pt communication network (e.g., a signal of the BC1 band) and a signal of the 2^{nd} communication network (e.g., a signal of the B4 band) and route the signals to the 2^{nd} RFIC 132.

The 1^{st} RFIC 130 may control an operation of providing a signal to the main antenna 110 and an operation of receiving a signal from at least one of the main antenna 110 or the sub antenna 112. According to one example embodiment, the 1^{st} RFIC 130 may convert a Radio Frequency (RF) signal of a low frequency band (e.g., the BC0 band for the 1^{st} communication network, the B13 band of the 2^{nd} communication network), provided from at least one of the 1^{st} FEU 120 or the 2^{nd} FEU 122, into a baseband signal, and may route the signal to the communication control module 140 (e.g., a 1^{st} communication control module 142 or a 2^{nd} communication control module 144). The 1^{st} RFIC 130 may convert an analog signal corresponding to a baseband signal provided from the communication control module 140 into an RF signal, and may route the signal to the 1^{st} FEU 120.

The 2^{nd} RFIC 132 may control an operation of receiving a signal from at least one of the main antenna 110 or the sub antenna 112. According to one example embodiment, the 2^{nd} RFIC 132 may convert an RF signal of a high frequency band (e.g., the BC1 band of the 1^{st} communication network, the B4 band of the 2^{nd} communication network), provided from at least one of the 1^{st} FEU 120 or the 2^{nd} FEU 122, into a baseband signal, or may route the signal to the communication control module 140 (e.g., the 1^{st} communication control module 142 or the 2^{nd} communication control module 144).

According to one example embodiment, in case of providing an LTE service, the 1^{st} RFIC 130 and the 2^{nd} RFIC 132 may process signals of different frequency bands (e.g., the B4 band or the B13 band) of an LTE communication network (e.g., the 2^{nd} communication network), received through the main antenna 110 and the sub antenna 112, and may provide the LTE service by using a carrier aggregation scheme.

According to one example embodiment, if a time for identifying a control signal of a CS network (e.g., an identification period) arrives, is detected, or expires, the electronic device 100 (e.g., the communication control module 140) may identify the control signal of the CS network (e.g., a signal of the BC0 band) by selecting a signal of the 1^{st} communication network among signals provided from the 1^{st} FEU 120 through the 1^{st} RFIC 130, i.e., the signal of the 1^{st} communication network (e.g., a signal of the BC0 band) and a signal of the 2^{nd} communication signal (e.g., a signal of the B13 band).

In this case, the electronic device 100 may be able to maintain the LTE service by providing a signal of the 2^{nd} communication network (e.g., a signal of the B13 band) to the 1^{st} FEU 120 through the 1^{st} RFIC 130 or by processing the 2^{nd} communication network signal (e.g., a signal of the B13 band) provided from the 2^{nd} FEU 122, during an operation identifying the control signal of the CS network through the 1^{st} RFIC 130. In addition, the electronic device 100 may be able to maintain the LTE service by processing a signal of the 2^{nd} communication network (e.g., a signal of the B4 band), received through the main antenna 110 and the sub antenna 112 from the 2^{nd} RFIC 132, during the operation identifying the control signal of the CS network through the RFIC 130.

According to one example embodiment, if a time of identifying a control signal of a CS network (e.g., an identification period) arrives, is detected, or expires, the electronic device 100 (e.g., the communication control module 140) may identify the control signal of the CS network (e.g., a signal of the BC1 band) by selecting a signal of the 1^{st} communication network from among signals provided from the 1^{st} FEU 120 through the 2^{nd} RFIC 132, i.e., the signal of the 1^{st} communication network (e.g., a signal of the BC1 band) and a signal of the 2^{nd} communication signal (e.g., a signal of the B4 band).

In this case, the electronic device 100 may be able to maintain the LTE service by providing a signal of the 2^{nd} communication network signal (e.g., a signal of the B4 band) to the 1^{st} FEU 120 through the 2^{nd} RFIC 132 or by processing the 2^{nd} communication network signal (e.g., a signal of the B4 band) provided from the 2^{nd} FEU 122 through the 2^{nd} RFIC 132, during the operation of identifying the control signal of the CS network through the 1^{st} RFIC 130.

The communication control module 140 may process (e.g., demodulate) at least one communication network signal included in a signal received from at least one of the 1^{st} RFIC 130 or the 2^{nd} RFIC 132. For example, the communication control module 140 may include the 1^{st} communication control module 142 (e.g., a modem) and the 2^{nd} communication control module 144 (e.g., a modem) which are separated logically or physically and process (or demodulate) a signal of a plurality of communication networks. For instance, the 1^{st} communication control module 142 may process a signal of the 1^{st} communication network (e.g., CDMA) (or a signal of the 2^{nd} communication network), and the 2^{nd} communication control module 144 may process a signal of the 2^{nd} communication network (e.g., LTE) (or a signal of the 1^{st} communication network).

According to one example embodiment, the 1^{st} communication control module 142 may provide a voice call service by using the signal of the 1^{st} communication network, processed (e.g., modulated) in the 1^{st} communication control module 142. In addition, the 2^{nd} communication control module 144 may provide a data service (e.g., Internet, SNS services) or a voice call service (e.g., Voice of LTE “VoLTE”) by using the signal of the 2^{nd} communication network, processed (e.g., modulated) in the 2^{nd} communication control module 144.

According to one example embodiment, the 1^{st} RFIC 130 and the 2^{nd} FEU 122 of the electronic device 100 may be separated logically or physically in one RFIC module.

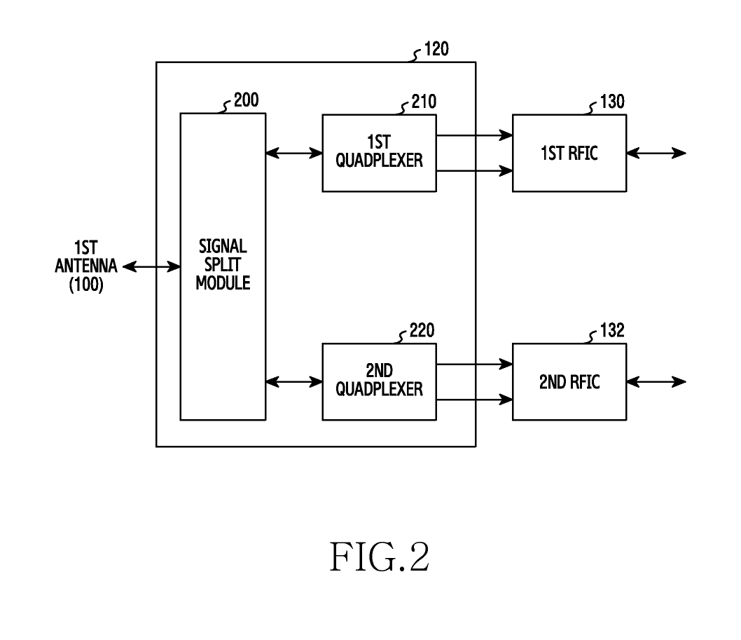

FIG. 2 illustrates a block diagram of a 1^{st} FEU in detail according to an example embodiment of the present disclosure.

Referring to FIG. 2, the 1^{st} FEU 120 may include a signal split module 200, a 1^{st} quadplexer 210, and a 2^{nd} quadplexer 220.

The signal split module 200 may split a signal received through the main antenna 110 into a plurality of signals to be routed (typically respectively) through a plurality of RFICs (e.g., the 1^{st} RFIC 130 or the 2^{nd} RFIC 132). According to one example embodiment, the signal split module 200 may include a diplexer, and thus may split the signal received through the main antenna 110 into a signal of a high frequency band (e.g., a BC1 band of a 1^{st} communication network, a B4 band of a 2^{nd} communication network) or a signal of a low frequency band (e.g., a BC0 band of the 1^{st} communication network, a B13 band of the 2^{nd} communication network).

The 1^{st} quadplexer 210 may split a low frequency band signal split by the signal split module 200 into a signal of the 1^{st} communication network (e.g., a signal of the BC0 band) and a signal of the 2^{nd} communication network (e.g., a signal of the B13 band) and route the signals through the 1^{st} RFIC 130. According to one example embodiment, the 1st quadplexer 210 may include a plurality of filters through which signals of different frequency bands pass. The 1^{st} quadplexer 210 may split the signal of the 1^{st} communication network from the low frequency band signal split by the signal split module 200 by using a 1^{st} filter through which only a reception signal of the 1^{st} communication network (e.g., a signal of the BC0 band) passes, and may route the signal to the 1^{st} RFIC 130. The 1^{st} quadplexer 210 may split the signal of the 2^{nd} communication network from the low frequency band signal split by the signal split module 200 by using a 2^{nd} filter through which only a reception signal of the 2^{nd} communication network (e.g., a signal of the B13 band) passes, and may route the signal to the 1^{st} RFIC 130.

The 2^{nd} quadplexer 220 may split a high frequency band signal split by the signal split module 200 into a signal of the 1^{st} communication network (e.g., a signal of the BC1 band) and a signal of the 2^{nd} communication network (e.g., a signal of the B4 band) and route the signals through the 2^{nd} RFIC 132. According to one example embodiment, the 2^{nd} quadplexer 220 may include a plurality of filters through which signals of different frequency bands pass. The 2^{nd} quadplexer 220 may split the signal of the 1^{st} communication network from the high frequency band signal split by the signal split module 200 by using a 3rd filter through which only a reception signal of the 1^{st} communication network (e.g., the signal of the BC1 band) passes, and may route the signal to the 2^{nd} RFIC 132. The 2^{nd} quadplexer 220 may split the signal of the 2^{nd} communication network from the high frequency band signal split by the signal split module 200 utilizing a 4th filter through which only a reception signal of the 2^{nd} communication network (e.g., the signal of the B4 band) passes, and may route the signal to the 2^{nd} RFIC 132.

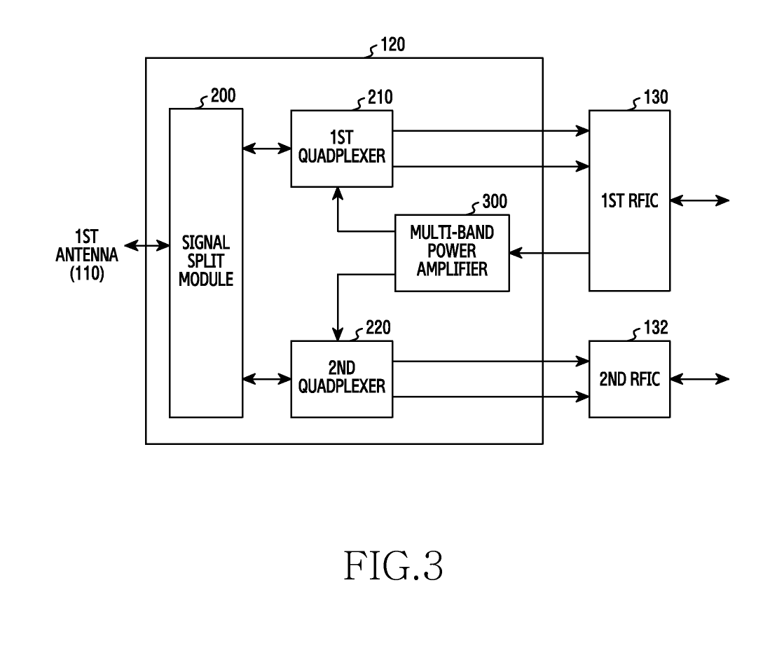

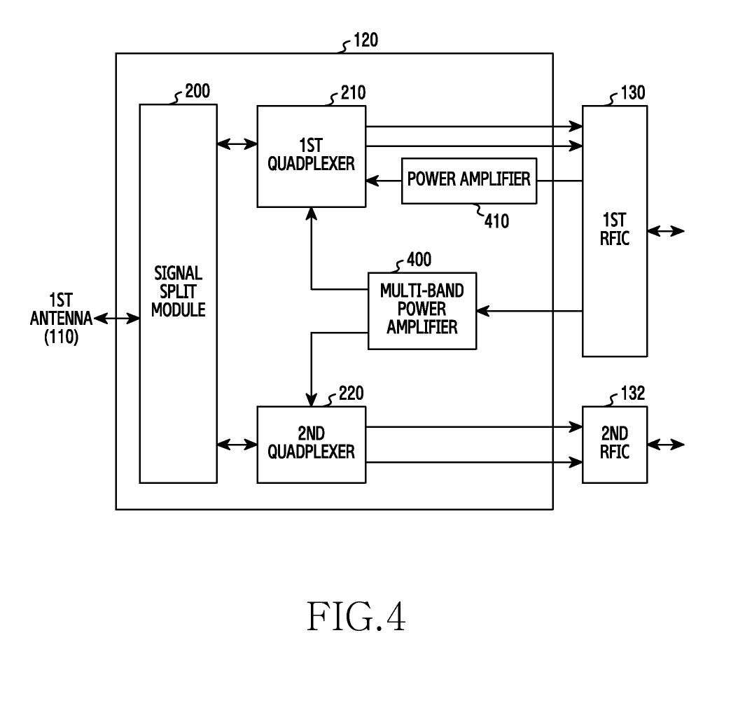

According to various example embodiments of the present disclosure, the 1^{st} FEU 120 may further include a power amplifier for signal transmission as shown in FIG. 3 and/or FIG. 4, described below.

FIG. 3 illustrates a block diagram of a 1^{st} FEU in detail according to an example embodiment of the present disclosure.

Referring to FIG. 3, the 1^{st} FEU 120 may include a signal split module 200, a 1^{st} quadplexer 210, a 2^{nd} quadplexer 220, and a multi-band power amplifier 300. For example, a signal reception operation performed in the 1^{st} FED 120 utilizing the signal split module 200, the 1^{st} quadplexer 210, or the 2^{nd} quadplexer 220 may be the same as the signal reception operation described in FIG. 2, and thus, a description of the signal reception operation based on the 1^{st} FEU 120 is omitted.

The multi-band power amplifier 300 may amplify power of an RF signal provided from the 1^{st} RFIC 130, in accordance with a characteristic of a communication service. In one example embodiment, the multi-band power amplifier 300 may amplify the power of a low frequency band signal (e.g., a signal of a BC0 band or a signal of a B13 band) provided from the 1^{st} RFIC 130, and may then output the amplified signal to the 1^{st} quadplexer 210. The multi-band power amplifier 300 may amplify power of a high frequency band signal (e.g., a signal of a BC1 band or a signal of a B4 band) provided from the 1^{st} RFIC 130, and then may route the signal to the 2^{nd} quadplexer 220.

The 1^{st} quadplexer 210 may route to the signal split module 200 an amplified signal provided from the multi-band power amplifier 300. According to one example embodiment, the 1^{st} quadplexer 210 may separate a signal of a 1^{st} communication network from a signal amplified in the multi-band power amplifier 300 through a 5th filter through which only a signal transmitted through the 1^{st} communication network (e.g., a signal of the BC0 band) passes, and then may route the signal to the signal split module 200. The 1st quadplexer 210 may separate a signal of a 2^{nd} communication network from a signal amplified in the multi-band power amplifier 300 through a 6^{th} filter through which only a signal transmitted through the 2^{nd} communication network (e.g., a signal of the B13 band) passes, and then may route the signal to the signal split module 200.

The 2^{nd} quadplexer 220 may route to the signal split module 200 an amplified signal provided from the multi-band power amplifier 300. According to one example embodiment, the 2^{nd} quadplexer 220 may separate a signal of the 1^{st} communication network from a signal amplified in the multi-band power amplifier 300 through a 7^{th} filter through which only a signal transmitted through the 1^{st} communication network (e.g., a signal of the BC1 band) passes, and then may route the signal to the signal split module 200. The 2^{nd} quadplexer 220 may separate a signal of the 2^{nd} communication network from a signal amplified in the multi-band power amplifier 300 through an 8^{th} filter through which only a signal transmitted through the 2^{nd} communication network (e.g., a signal of the B4 band) passes, and then may route the signal to the signal split module 200.

The signal split module 200 may combine signals provided from at least one of the 1^{st} quadplexer 210 or the 2^{nd} quadplexer 220 into one signal, and then may route the signal to the main antenna 110.

FIG. 4 illustrates a block diagram of a 1^{st} FEU in detail according to an example embodiment of the present disclosure.

Referring to FIG. 4, the 1^{st} FEU 120 may include a signal split module 200, a 1^{st} quadplexer 210, a 2^{nd} quadplexer 220, a multi-band power amplifier 400, and a power amplifier 410. For example, a signal reception operation performed in the 1^{st} FED 120 by using the signal split module 200, the 1^{st} quadplexer 210, or the 2^{nd} quadplexer 220 may be the same as the signal reception operation described in FIG. 2, and thus, a description of the signal reception operation based on the 1^{st} FEU 120 is omitted.

The multi-band power amplifier 400 may amplify power of an RF signal for a high frequency band (e.g., a B4 band) of a 2^{nd} communication network or a band (e.g., a band BC0 or a band BC1) of a 1^{st} communication network, provided from the 1^{st} RFIC 130, in accordance with a characteristic of a communication service. In one example embodiment, the multi-band power amplifier 400 may amplify power of a low frequency band signal of the 1^{st} communication network, provided from the 1^{st} RFIC 130, and then may route the signal to the 1^{st} quadplexer 210. The multi-band power amplifier 400 may amplify power of a high frequency band signal (e.g., a signal of the BC1 band or a signal of the B4 band) provided from the 1^{st} RFIC 130, and then may route the signal to the 2^{nd} quadplexer 220.

The power amplifier 410 may amplify power of an RF signal for a low frequency band (e.g., a B13 band) of the 2^{nd} communication network, provided from the 1^{st} RFIC 130, in accordance with a characteristic of the 2^{nd} communication network. In one example embodiment, the power amplifier 410 may amplify power of a low frequency band signal of the 2^{nd} communication network, provided from the 1^{st} RFIC 130, and then may route the signal to the 1^{st} quadplexer 210.

The 1^{st} quadplexer 210 may route to the signal split module 200 an amplified signal provided from at least one of the multi-band power amplifier 400 or the power amplifier 410. According to one example embodiment, the 1^{st} quadplexer 210 may separate a signal of the 1^{st} communication network from a signal amplified in any one of the multi-band power amplifier 400 and the power amplifier 410 through a 5th filter through which only a signal transmitted through the 1^{st} communication network (e.g., a signal of the BC0 band) passes, and then may route the signal to the signal split module 200. The 1^{st} quadplexer 210 may separate a signal of the 2^{nd} communication network from a signal amplified in any one of the multi-band power amplifier 400 and the power amplifier 410 through a 6th filter through which only a signal transmitted through the 2^{nd} communication network (e.g., a signal of the B13 band) passes, and then may route the signal to the signal split module 200.

The 2^{nd} quadplexer 220 may route to the signal split module 200 an amplified signal provided from the multi-band power amplifier 400. According to one example embodiment, the 2^{nd} quadplexer 220 may separate a signal of the 1^{st} communication network from a signal amplified in the multi-band power amplifier 400 through a 7th filter through which only a signal transmitted through the 1^{st} communication network (e.g., the BC1 band signal) passes, and then may route the signal to the signal split module 200. The 2^{nd} quadplexer 220 may separate a signal of the 2^{nd} communication network from a signal amplified in the multi-band power amplifier 400 through an 8^{th} filter through which only a signal transmitted through the 2^{nd} communication network (e.g., the B4 band signal) passes, and then may route the signal to the signal split module 200.

The signal split module 200 may combine signals provided from at least one of the 1^{st} quadplexer 210 or the 2^{nd} quadplexer 220 into one signal, and then may route the signal to the main antenna 110.

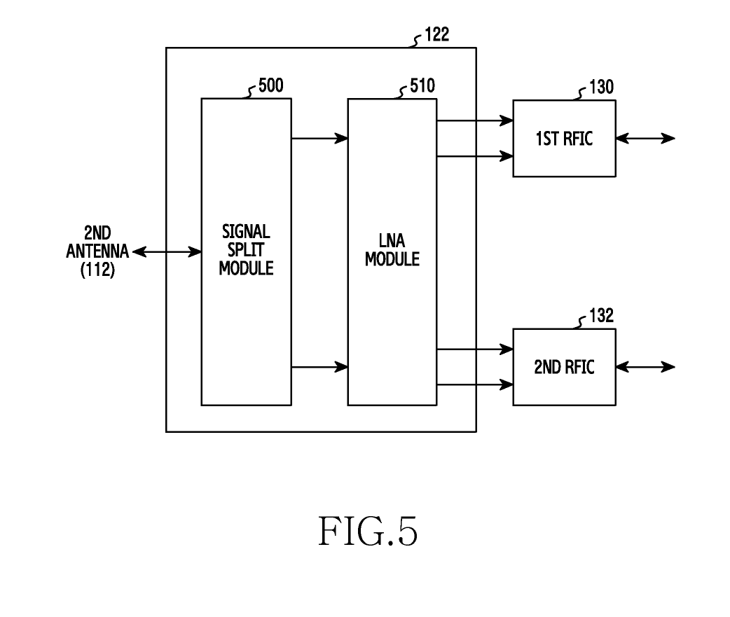

FIG. 5 illustrates a block diagram of a 2^{nd} FEU in detail according to an example embodiment of the present disclosure.

Referring to FIG. 5, the 2^{nd} FEU 122 may include a signal split module 500 and a Low Noise Amplifier (LNA) module 510.

The signal split module 500 may split a signal received through the sub antenna 112 into a plurality of signals to be routed through a plurality of RFICs (e.g., the 1^{st} RFIC 130 or the 2^{nd} RFIC 132), respectively. According to one example embodiment, the signal split module 500 may include a diplexer or at least one signal splitter. The diplexer may split the signal received through the sub antenna 112 into a signal of a high frequency band (e.g., a BC1 band of a 1^{st} communication network, a B4 band of a 2^{nd} communication network) or a signal of a low frequency band (e.g., a BC0 band of the 1^{st} communication network, a B13 band of the 2^{nd} communication network) through the sub antenna 112. A 1^{st} signal splitter may split a low frequency band signal provided from the diplexer into a signal of the 1^{st} communication network (e.g., a signal of the BC0 band) and a signal of the 2^{nd} communication network (e.g., a signal of the B13 band). A 2^{nd} signal splitter may split a high frequency band signal provided from the diplexer into a signal of the 1^{st} communication network (e.g., a signal of the BC1 band) and a signal of the 2^{nd} communication network (e.g., a signal of the B4 band). According to one example embodiment, the 1^{st} signal splitter and the 2^{nd} signal splitter may be included by being separated logically and physically.

The LNA module 510 may perform low noise amplification on a signal for each of communication services separated by the signal split module 500 and may route the signal through the 1^{st} RFIC 130 or the 2^{nd} RFIC 132. According to one example embodiment, the LNA module 510 may include a plurality of amplifiers for amplify signals of different frequency bands.

According to various example embodiments of the present disclosure, an electronic device may include a 1^{st} antenna for transmitting/receiving a signal by using at least one of a 1^{st} communication network or a 2^{nd} communication network, a 2^{nd} antenna for receiving a signal by using at least one of the 1^{st} communication network or the 2^{nd} communication network, a 1^{st} Front End Unit (FEU) for splitting the signal received through the 1^{st} antenna into a plurality of frequency band signals for the 1^{st} communication network or a plurality of frequency band signals for the 2^{nd} communication network, a 2^{nd} FEU for splitting the signal received through the 2^{nd} antenna into a plurality of frequency band signals for the Pt communication network or a plurality of frequency band signals for the 2^{nd} communication network, a 1^{st} Radio Frequency Integrated Chip (RFIC) for processing a 1^{st} frequency band signal provided from the 1^{st} FEU or the 2^{nd} FEU among the plurality of frequency band signals for the 2^{nd} communication network, and a 2^{nd} RFIC for processing a 2^{nd} frequency band signal provided from the 1^{st} FEU or the 2^{nd} FEU among the plurality of frequency band signals for the 2^{nd} communication network. The 1^{st} RFIC may process a 3rd frequency band signal provided from the 1^{st} FEU at a time of identifying the 3rd frequency band signal of the 1^{st} communication network, and may process the Pt frequency band signal provided from the 2^{nd} FEU.

In the example embodiment of the present disclosure, the Pt RFIC may transmit to the Pt FEU a signal for at least one of the Pt communication network or the 2^{nd} communication network, and may transmit to the Pt FEU the Pt frequency band signal of the 2^{nd} communication network at the time of identifying the signal.

In the example embodiment of the present disclosure, the Pt FEU may include at least one power amplification module for amplifying power of a signal provided from the 1^{st} RFIC according to a characteristic of a communication network for transmitting the signal.

In the example embodiment of the present disclosure, the 1^{st} FEU may include a signal split module for splitting the signal of the 1^{st} or 2^{nd} communication network, received through the 1^{st} antenna, into a low frequency band signal and a high frequency band signal, a 1^{st} quadplexer for splitting the low frequency band signal into the 3^{rd} frequency band signal of the 1^{st} communication network and the 1^{st} frequency band signal of the 2^{nd} communication network, and a 2^{nd} quadplexer for splitting the high frequency band signal into a 4th frequency band signal of the 1^{st} communication network and the 2^{nd} frequency band signal of the 2^{nd} communication network.

In the example embodiment of the present disclosure, the 1^{st} quadplexer may include a plurality of filters for filtering different frequency band signals to split the signals into the 3rd frequency band signal of the 1^{st} communication network and the 1^{st} frequency band signal of the 2^{nd} communication network by using the respective filters, and the 2^{nd} quadplexer may include a plurality of filters for filtering different frequency band signals to split the signals into the 4^{th} frequency band signal of the 1^{st} communication network and the 2^{nd} frequency band signal of the 2^{nd} communication network by using the respective filters.

In the example embodiment of the present disclosure, the 2^{nd} FEU may include a signal split module for splitting a signal received through the 2^{nd} antenna into a plurality of frequency band signals for the 1^{st} communication network or a plurality of frequency band signals for the 2^{nd} communication network, and at least one Low Noise Amplifier (LNA) module for performing low frequency amplification on respective frequency band signals split by the signal split module.

In the example embodiment of the present disclosure, the 1^{st} communication network may include at least one of Code Division Multiple Access (CDMA), Wideband CDMA (WCDMA), Time Division-Synchronous CDMA (TD-SCDMA), Evolution-Data Optimized (EV-DO), or Global System for Mobile communications (GSM).

In the example embodiment of the present disclosure, the 2^{nd} communication network may include at least one of Long Term Evolution (LTE) or mobile WiMAX.

In the example embodiment of the present disclosure, the 2^{nd} RFIC may process a 4^{th} frequency band signal provided from the 1^{st} FEU at a time of identifying the 4^{th} frequency band signal of the 1^{st} communication network, and may process the 2^{nd} frequency band signal provided from the 2^{nd} FEU.

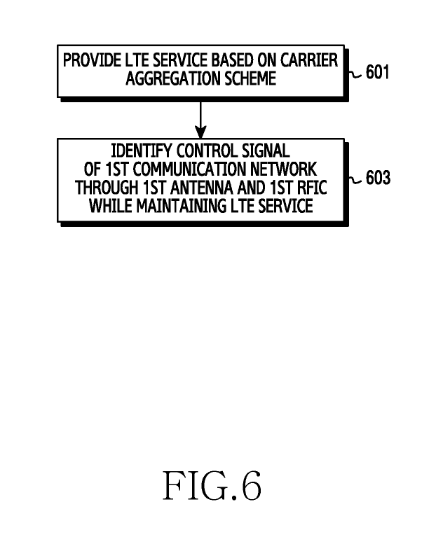

FIG. 6 illustrates a process of receiving a control signal of a CS network during an LTE service in an electronic device according to an example embodiment of the present disclosure.

Referring to FIG. 6, the electronic device (e.g., the electronic device 100) may provide the LTE service on the basis of a carrier aggregation scheme in operation 601. According to one example embodiment, the electronic device 100 may process a signal for a 1^{st} frequency band and a 2^{nd} frequency band of a 2^{nd} communication network (e.g., an LTE network), received through at least one of the main antenna 110 or the sub antenna 112 by using the 1^{st} RFIC 130 and the 2^{nd} RFIC 132, and may provide the LTE service on the basis of the carrier aggregation scheme.

In operation 603, the electronic device may identify a signal of a 1^{st} communication network (e.g., a CS network), received through the main antenna 110 by using the 1^{st} RFIC 130 while maintaining the LTE service. According to one example embodiment, if a time of identifying the control signal of the CS network (e.g., a paging period) arrives, the 1^{st} RFIC 130 may identify whether the control signal of the CS network (e.g., a signal of a BC0 band) is received by using the 1^{st} communication network signal provided from the 1^{st} FEU 120. In this case, the electronic device 100 may be able to maintain the LTE service by transmitting a signal of the 2^{nd} communication network (e.g., a signal of a B13 band) to the 1^{st} FEU 120 through the 1^{st} RFIC 130 or by processing the 2^{nd} communication network signal (e.g., the signal of the B13 band) provided from the 2^{nd} FEU 122. According to one example embodiment, if a time of identifying the control signal of the CS network (e.g., the paging period) arrives, the 2^{nd} RFIC 132 may identify whether the control signal of the CS network (e.g., a signal of a BC1 band) is received by using the 1^{st} communication network signal provided from the 1^{st} FEU 120. In this case, the electronic device 100 may be able to maintain the LTE service by transmitting a signal of the 2^{nd} communication network (e.g., a signal of a B4 band) to the 1^{st} FEU 120 through the 1^{st} RFIC 130 or by processing the 2^{nd} communication network signal (e.g., a signal of the B4 band) provided from the 2^{nd} FEU 122 through the 2^{nd} RFIC 132.

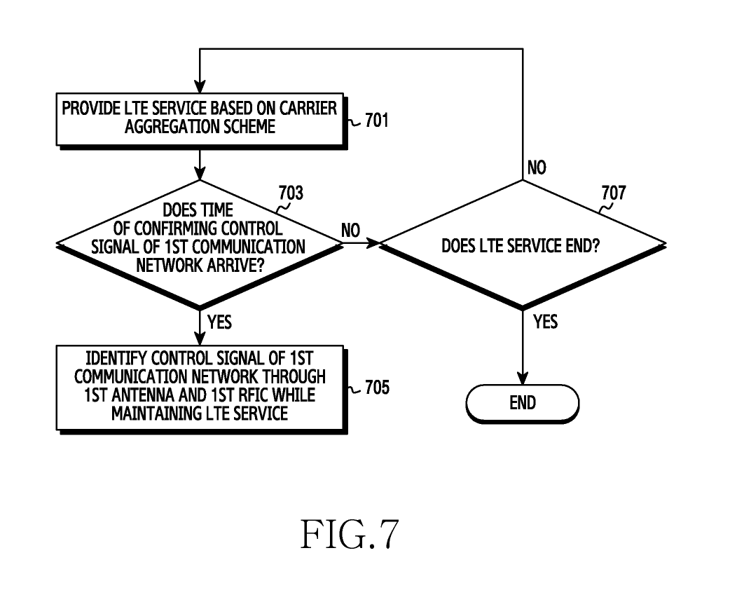

FIG. 7 illustrates a process of receiving a control signal of a CS network during an LTE service in an electronic device according to an example embodiment of the present disclosure.

Referring to FIG. 7, the electronic device (e.g., the electronic device 100) may provide the LTE service on the basis of a carrier aggregation scheme in operation 701. According to one example embodiment, the electronic device 100 may process signals for different frequency bands of a 2^{nd} communication network through the 1^{st} RFIC 130 and the 2^{nd} RFIC 132, and may provide the LTE service on the basis of the carrier aggregation scheme.

In operation 703, the electronic device may identify whether a time of identifying the control signal of the CS network arrives during the LTE service. According to one example embodiment, the electronic device may identify whether a paging period arrives.

If the time of identifying the control signal of the CS network does not arrive in operation 703, the electronic device may identify whether the LTE service ends in operation 707.

If the LTE service does not end in operation 707, the electronic device may maintain the LTE service in operation 701. According to one example embodiment, the electronic device may provide the LTE service on the basis of the carrier aggregation scheme.

If the LTE service ends in operation 707, the electronic device may end the procedure of FIG. 7.

If the time of identifying the control signal of the CS network arrives in operation 703, the electronic device may identify a signal of a 1^{st} communication network (e.g., the CS network), received through the main antenna 110 by using the 1^{st} RFIC 130 in operation 705 while maintaining the LTE service.

According to one example embodiment, when the LTE service is provided, the 1^{st} RFIC 130 of the electronic device 100 may provide the LTE service by selecting a 2^{nd} communication network signal between a 1^{st} communication network signal (e.g., a signal of a BC0 band) and the 2^{nd} communication network signal (e.g., a signal of a B13 band) provided from the 1^{st} FEU 120. If a time of identifying the control signal of the CS network (e.g., a paging period) arrives, the 1^{st} RFIC 130 may identify whether the control signal of the CS network (e.g., a signal of the BC0 band) is received by selecting the 1^{st} communication network signal between the 1^{st} communication network signal and the 2^{nd} communication network signal provided from the 1^{st} FEU 120.

In this case, the electronic device 100 may be able to maintain the LTE service by transmitting 2^{nd} communication network signal (e.g., a signal of the B13 band) to the 1^{st} FEU 120 through the 1^{st} RFIC 130 or by processing the 2^{nd} communication network signal (e.g., the signal of a B13 band) provided from the 2^{nd} FEU 122. In addition, the electronic device 100 may be able to maintain the LTE service by processing the 2^{nd} communication network signal (e.g., a signal of a B4 band) received through the main antenna 110 and the sub antenna 112 from the 2^{nd} RFIC 132 during the operation of identifying the control signal of the CS network through the RFIC 130.

According to one example embodiment, when the LTE service is provided, the 2^{nd} RFIC 132 of the electronic device 100 may provide the LTE service by selecting the 2^{nd} communication network signal between the 1^{st} communication network signal (e.g., a signal of the BC1 band) and the 2^{nd} communication network signal (e.g., a signal of the B4 band) provided from the 1^{st} FEU 120. If a time of identifying the control signal of the CS network (e.g., the paging period) arrives, the 2^{nd} RFIC 132 may identify whether the control signal of the CS network (e.g., the signal of the BC1 band) is received by selecting the 1^{st} communication network signal between the 1^{st} communication network signal and the 2^{nd} communication network signal provided from the 1^{st} FEU 120.

In this case, the electronic device 100 may be able to maintain the LTE service by transmitting the 2^{nd} communication network signal (e.g., the signal of the B4 band) to the 1^{st} FEU 120 through the 2^{nd} RFIC 132 or by processing the 2^{nd} communication network signal (e.g., the signal of the B4 band) provided from the 2^{nd} FEU 122 through the 2^{nd} RFIC 132.

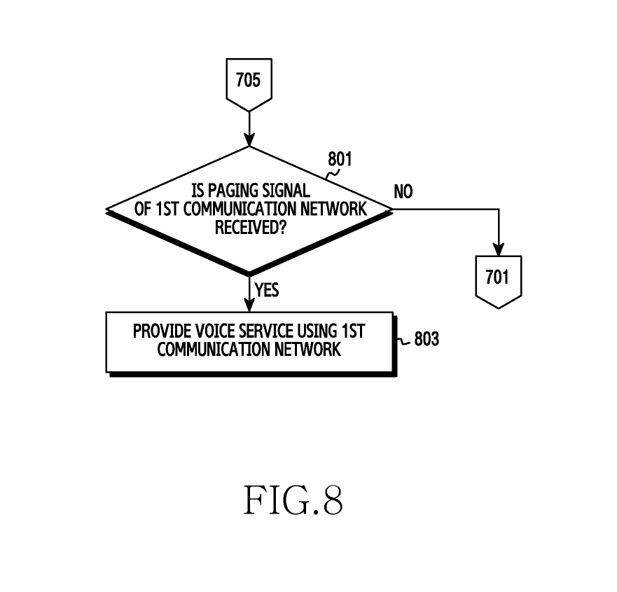

FIG. 8 illustrates a process of switching a communication service in an electronic device according to an example embodiment of the present disclosure.

Referring to FIG. 8, if a 1^{st} communication network (e.g., CS network) signal received through the main antenna 110 by using the 1^{st} RFIC 130 is identified in operation 705 of FIG. 7, the electronic device (e.g., the electronic device 100) may identify whether a CS network paging signal is received in operation 801. According to one example embodiment, the electronic device may identify whether the paging signal is included in the 1^{st} communication network signal.

If the paging signal is not received in operation 801, the electronic device may maintain an LTE service in operation 701 of FIG. 7.

If the paging signal is received in operation 801, the electronic device may switch a communication network for providing a service to a 1^{st} communication network and thus may provide a voice communication service using the CS network in operation 803.

According to various example embodiments of the present disclosure, a method of operating an electronic device may include processing signals for different frequency bands of a 2^{nd} communication network through a plurality of Radio Frequency Integrated chips (RFICs), and identifying whether a signal of a 1^{st} communication network is received through a 1^{st} antenna in a 1^{st} RFIC among the plurality of RFICs in response to a time of identifying the signal of the 1^{st} communication network, and processing a signal of the 2^{nd} communication network, received through the 2^{nd} communication network. The 1^{st} antenna may transmit/receive a signal by using at least one of the 1^{st} communication network or the 2^{nd} communication network. The 2^{nd} antenna may receive a signal by using at least one of the 1^{st} communication network or the 2^{nd} communication network.

In the example embodiment of the present disclosure, the method may further include transmitting the signal of the 2^{nd} communication network in the 1^{st} RFIC in response to the time of identifying the signal of the 1^{st} communication network.

In the example embodiment of the present disclosure, the 1^{st} communication network may include at least one of Code Division Multiple Access (CDMA), Wideband CDMA (WCDMA), Time Division-Synchronous CDMA (TD-SCDMA), Evolution-Data Optimized (EV-DO), or Global System for Mobile communications (GSM).

In the example embodiment of the present disclosure, the 2^{nd} communication network may include at least one of Long Term Evolution (LTE) or mobile WiMAX.

In the example embodiment of the present disclosure, the identifying of whether the signal of the 1^{st} communication network is received may include identifying whether a paging signal for a 1^{st} frequency band of the 1^{st} communication network is received through the 1^{st} antenna in the 1^{st} RFIC in response to arrival of a time of identifying the signal of the 1^{st} communication network.

In the example embodiment of the present disclosure, the method may further include identifying whether a signal for a 2^{nd} frequency band is received through the 1^{st} antenna in the 2^{nd} RFIC among the plurality of RFICs in response to arrival of a time of identifying the signal for the 2^{nd} frequency band of the Pt communication network, and processing the signal of the 2^{nd} communication network, received through the 2^{nd} antenna.

In the example embodiment of the present disclosure, the method may further include transmitting the signal of the 2^{nd} communication network to the 1^{st} antenna in the 1^{st} RFIC in response to a time of identifying the signal for the 2^{nd} frequency band of the 1^{st} communication network.

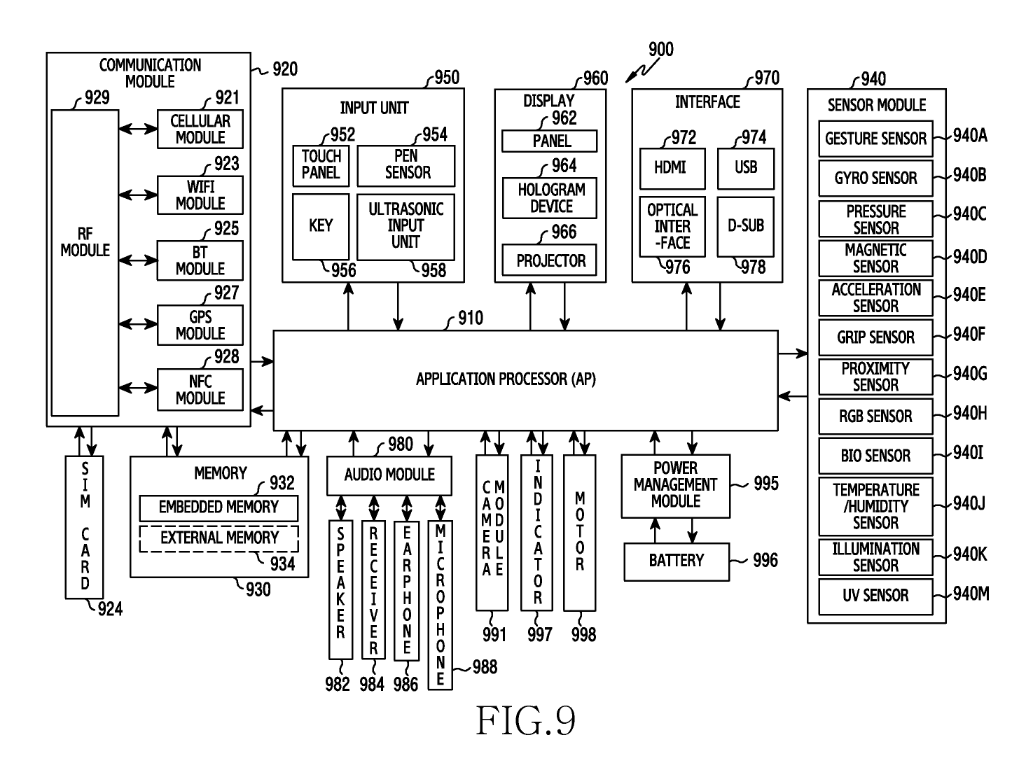

FIG. 9 illustrates a block diagram of an electronic device according to various example embodiments. For example, an electronic device 900 may constitute all or some parts of the electronic device 100 of FIG. 1.

Referring to FIG. 9, the electronic device 900 includes at least one Application Processor (AP) 910, a communication module 920, a Subscriber Identification Module (SIM) card 924, a memory 930, a sensor module 940, an input unit 950, a display 960, an interface 970, an audio module 980, a camera module 991, a power management module 995, a battery 996, an indicator 997, and a motor 998.

The AP 910 may control a plurality of hardware or software constitutional elements connected to the AP 910 by driving an operating system or an application program, and may process a variety of data including multimedia data and may perform an arithmetic operation. The AP 910 may be implemented, for example, with a System on Chip (SoC). According to one example embodiment, the AP 910 may further include a Graphic Processing Unit (GPU, not shown).

The communication module 920 may perform data transmission/reception in communication between other electronic devices connected with the electronic device 900 through a network. According to one example embodiment, the communication module 920 may include a cellular module 921, a Wi-Fi module 923, a BlueTooth (BT) module 925, a Global Positioning System (GPS) module 927, a Near Field Communication (NFC) module 928, and a Radio Frequency (RF) module 929.

The cellular module 921 may provide a voice call, a video call, a text service, an internet service, and the like through a communication network (e.g., LTE, LTE-A, CDMA, WCDMA, UMTS, WiBro, GSM, etc.). In addition, the cellular module 921 may identify and authenticate the electronic device within the communication network by using a subscriber identity module (e.g., the SIM card 924). According to one example embodiment, the cellular module 921 may perform at least some of functions that can be provided by the AP 910. For example, the cellular module 921 may perform at least some of multimedia control functions.

According to one example embodiment, the cellular module 921 may include a Communication Processor (CP). Further, the cellular module 921 may be implemented, for example, with an SoC. Although constitutional elements such as the cellular module 921 (e.g., the communication processor), the memory 930, the power management module 995, and the like are illustrated as separate constitutional elements with respect to the AP 910 in FIG. 9, the AP 910 may also be implemented such that at least one part (e.g., the cellular module 921) of the aforementioned constitutional elements is included.

According to one example embodiment, the AP 910 or the cellular module 921 (e.g., the communication processor) may load an instruction or data, which is received from each non-volatile memory connected thereto or at least one of different constitutional elements, to a volatile memory and may process the instruction or data. In addition, the AP 910 or the cellular module 921 may store data, which is received from at least one of different constitutional elements or generated by at least one of different constitutional elements, into the non-volatile memory.

Each of the WiFi module 923, the BT module 925, the GPS module 927, and the NFC module 928 may include, for example, a processor for processing data transmitted/received through a corresponding module. Although the cellular module 921, the WiFi module 923, the BT module 925, the GPS module 927, and the NFC module 928 are illustrated in FIG. 9 as separate blocks, according to one example embodiment, at least some (e.g., two or more) of the cellular module 921, the WiFi module 923, the BT module 925, the GPS module 927, and the NFC module 928 may be included in one Integrated Chip (IC) or IC package. For example, at least some of processors corresponding to the cellular module 921, the WiFi module 923, the BT module 925, the GPS module 927, and the NFC module 928 (e.g., a communication processor corresponding to the cellular module 921 and a WiFi processor corresponding to the WiFi module 923) may be implemented with an SoC.

The RF module 929 may serve to transmit/receive data, for example, to transmit/receive an RF signal. Although not shown, the RF module 929 may include, for example, a transceiver, a Power Amp Module (PAM), a frequency filter, a Low Noise Amplifier (LNA), and the like. In addition, the RF module 929 may further include a component for transmitting/receiving a radio wave on a free space in wireless communication, for example, a conductor, a conducting wire, and the like. Although it is illustrated in FIG. 9 that the cellular module 921, the WiFi module 923, the BT module 925, the GPS module 927, and the NFC module 928 share one RF module 929, according to one example embodiment, at least one of the cellular module 921, the WiFi module 923, the BT module 925, the GPS module 927, the NFC module 928 may transmit/receive an RF signal via a separate RF module.

According to one example embodiment, the RF module 929 may include at least one of a main antenna or a sub antenna operatively coupled to the electronic device 900. The communication module 920 may support multiple antenna techniques such as diversity, Multiple-Input Multiple-Output (MIMO), or the like by using the main antenna and the sub antenna.

The SIM card 924 may be a card in which a SIM is implemented, and may be inserted to a slot formed at a specific location of the electronic device. The SIM card 924 may include unique identification information (e.g., an Integrated Circuit Card IDentifier (ICCID)) or subscriber information (e.g., an International Mobile Subscriber Identity (IMSI)).

The memory 930 may include an internal memory 932 or an external memory 934. The internal memory 932 may include, for example, at least one of a volatile memory (e.g., a Dynamic RAM (DRAM), a Static RAM (SRAM), a Synchronous Dynamic RAM (SDRAM), etc.) or a non-volatile memory (e.g., a One Time Programmable ROM (OTPROM), a Programmable ROM (PROM), an Erasable and Programmable ROM (EPROM), an Electrically Erasable and Programmable ROM (EEPROM), a Mask ROM, a Flash ROM, a NAND flash memory, a NOR flash memory, etc.).

According to one example embodiment, the internal memory 932 may be a Solid State Drive (SSD). The external memory 934 may further include a flash drive, and may further include, for example, Compact Flash (CF), Secure Digital (SD), Micro Secure Digital (Micro-SD), Mini Secure digital (Mini-SD), extreme Digital (xD), memory stick, and the like. The external memory 934 may be operatively coupled to the electronic device 900 via various interfaces. According to one example embodiment, the electronic device 900 may further include a storage unit (or a storage medium) such as a hard drive.

The sensor module 940 may measure a physical quantity or detect an operation state of the electronic device 900, and thus may convert the measured or detected information into an electric signal. The sensor module 940 may include, for example, at least one of a gesture sensor 940A, a gyro sensor 940B, a pressure sensor 940C, a magnetic sensor 940D, an acceleration sensor 940E, a grip sensor 940F, a proximity sensor 940G, a color sensor 940H (e.g., a Red, Green, Blue (RGB) sensor), a bio sensor 940I, a temperature/humidity sensor 940J, an illumination sensor 940K, or an Ultra Violet (UV) sensor 940M. Additionally or alternatively, the sensor module 940 may include, for example, an E-nose sensor (not shown), an ElectroMyoGraphy (EMG) sensor (not shown), an ElectroEncephaloGram (EEG) sensor (not shown), an ElectroCardioGram (ECG) sensor (not shown), an Infra Red (IR) sensor (not shown), an iris sensor (not shown), a fingerprint sensor (not shown), and the like. The sensor module 940 may further include a control circuit for controlling at least one or more sensors included therein.

The input device 950 may include a touch panel 952, a (digital) pen sensor 954, a key 956, or an ultrasonic input unit 958. The touch panel 952 may recognize a touch input, for example, by using at least one of an electrostatic type, a pressure-sensitive type, or an ultrasonic type. The touch panel 952 may further include a control circuit. In case of the electrostatic type, not only a physical contact but also a proximity recognition is possible. The touch penal 952 may further include a tactile layer. In this case, the touch panel 952 may provide the user with a tactile reaction.

The (digital) pen sensor 954 may be implemented, for example, by using the same or similar method of receiving a touch input of the user or by using an additional sheet for recognition. The key 956 may be, for example, a physical button, an optical key, a keypad, or a touch key. The ultrasonic input unit 958 is a device by which the electronic device 900 detects a sound wave through a microphone 988 by using a pen which generates an ultrasonic signal, and is a device capable of radio recognition. According to one example embodiment, the electronic device 900 may use the communication module 920 to receive a user input from an external device (e.g., a computer or a server) connected thereto.

The display 960 may include a panel 962, a hologram 964, or a projector 966. The panel 962 may be, for example, a Liquid-Crystal Display (LCD), an Active-Matrix Organic Light-Emitting Diode (AM-OLED), and the like. The panel 962 may be implemented, for example, in a flexible, transparent, or wearable manner. The panel 962 may be implemented as one module with the touch panel 952. The hologram 964 may use an interference of light and show a stereoscopic image in the air. The projector 966 may display an image by projecting a light beam onto a screen. The screen may be located, for example, inside or outside the electronic device 900. According to one example embodiment, the display 960 may further include a control circuit for controlling the panel 962, the hologram 964, or the projector 966.

The interface 970 may include, for example, a High-Definition Multimedia Interface (HDMI) 972, a Universal Serial Bus (USB) 974, an optical communication interface 976, or a D-subminiature (D-sub) 978. Additionally or alternatively, the interface 970 may include, for example, a Mobile High-definition Link (MHL) interface, a Secure Digital (SD)/Multi-Media Card (MMC) interface, or an Infrared Data Association (IrDA) standard interface.

The audio module 980 may bilaterally convert a sound and electronic signal. The audio module 980 may convert sound information which is input or output, for example, through a speaker 982, a receiver 984, an earphone 986, the microphone 988, and the like.

The camera module 991 is a device for image and video capturing, and according to one example embodiment, may include one or more image sensors (e.g., a front sensor or a rear sensor), a lens (not shown), an Image Signal Processor (ISP) (not shown), or a flash (not shown, e.g., LED or xenon lamp).

The power management module 995 may manage a power of the electronic device 900. Although not shown, the power management module 995 may include, for example, a Power Management Integrated Circuit (PMIC), a charger Integrated Circuit (IC), or a battery fuel gauge.

The PMIC may be placed, for example, inside an IC or SoC semiconductor. Charging may be classified into wired charging and wireless charging. The charger IC may charge a battery, and may avoid an over-voltage or over-current flow from a charger. According to one example embodiment, the charger IC may further include a charger IC for at least one of the wired charging or the wireless charging. The wireless charging may be classified into, for example, a magnetic resonance type, a magnetic induction type, and an electromagnetic type. An additional circuit for the wireless charging, for example, a coil loop, a resonant circuit, a rectifier, and the like, may be added.

The battery gauge may measure, for example, a residual quantity of the battery 996 and a voltage, current, and temperature during charging. The battery 996 may store or generate an electricity, and may supply a power to the electronic device 900 by using the stored or generated electricity. For example, the battery 996 may include a rechargeable battery or a solar battery.

The indicator 997 may indicate a specific state, for example, a booting state, a message state, a charging state, and the like, of the electronic device 900 or a part thereof (e.g., the AP 910). The motor 998 may convert an electric signal into a mechanical vibration. Although not shown, the electronic device 900 may include a processing unit (e.g., a GPU) for supporting a mobile TV. The processing unit for supporting the mobile TV may process media data according to a protocol of, for example, Digital Multimedia Broadcasting (DMB), Digital Video Broadcasting (DVB), media flow, and the like.

According to various example embodiments of the present disclosure, a computer readable recording medium for recording a program may be included. The program is for executing operations of processing signals for different frequency bands of a 2^{nd} communication network through a plurality of Radio Frequency Integrated Chips (RFICs) in an electronic device having a 1^{st} antenna for transmitting/receiving a signal by using at least one of a 1^{st} communication network or the 2^{nd} communication network and a 2^{nd} antenna for receiving a signal by using at least one of the 1^{st} communication network or the 2^{nd} communication network, and identifying whether the signal of the 1^{st} communication network is received through the Pt antenna in the Pt RFIC among the plurality of RFICs in response to a time of identifying the signal of the 1^{st} communication network, and processing the signal of the 2^{nd} communication network, received through the 2^{nd} antenna.

According to various example embodiments, an electronic device having a plurality of antennas includes a Front-End-Unit (FEU) of a 1^{st} antenna configured to receive a control signal (e.g., a paging signal) for a CS network by using the 1^{st} antenna during an LTE service based on a carrier aggregation scheme, thereby being able to provide the LTE service based on the carrier aggregation scheme and being able to maintain the LTE service during the control signal for the CS network is received.

An electronic device having a main antenna and a sub antenna includes an FEU of the main antenna configured to receive a control signal (e.g., a paging signal) for a CS network by using the main antenna during an LTE service based on a carrier aggregation scheme, thereby being able to improve reception performance of the control signal for the CS network.

Each of the aforementioned constitutional elements of the electronic device according to various example embodiments of the present disclosure may consist of one or more components, and names thereof may vary depending on a type of electronic device. The electronic device according to various example embodiments of the present disclosure may include at least one of the aforementioned constitutional elements. Some of the constitutional elements may be omitted, or additional other constitutional elements may be further included. In addition, some of the constitutional elements of the electronic device according to various example embodiments of the present disclosure may be combined and implemented as one entity, so as to equally perform functions of corresponding constitutional elements before combination.

A term “module” used in various example embodiments of the present disclosure may imply a unit including, for example, one of hardware, software, and firmware or a combination of two or more of them. The “module” may be interchangeably used with a term such as a unit, a logic, a logical block, a component, a circuit, and the like. The “module” may be a minimum unit of an integrally constituted component or may be a part thereof. The “module” may be a minimum unit for performing one or more functions or may be a part thereof. The “module” may be mechanically or electrically implemented. For example, the “module” according to various example embodiments of the present disclosure may include at least one of an Application-Specific Integrated Circuit (ASIC) chip, a Field-Programmable Gate Arrays (FPGAs), or a programmable-logic device, which are known or will be developed and which perform certain operations.

According to various example embodiments, at least some parts of a device (e.g., modules or functions thereof) or method (e.g., operations) of the present disclosure may be implemented with an instruction stored in a computer-readable storage media for example. If the instruction is executed by one or more processors, the one or more processors may perform a function corresponding to the instruction. The computer-readable storage media may be, for example, the memory. At least some parts of the programming module may be implemented (e.g., executed), for example, by the processor. At least some parts of the programming module may include modules, programs, routines, sets of instructions, processes, and the like, for performing one or more functions.

The computer readable recording medium may be a hardware device configured particularly to store and perform a program instruction (e.g., program module), for example, a hard disk, a magnetic medium such as a floppy disc and a magnetic tape, an optical storage medium such as a Compact Disc-ROM (CD-ROM) or a Digital Versatile Disc (DVD), a magnetic-optic medium such as a floptical disc, a Read Only Memory (ROM), a Random Access Memory (RAM), a flash memory, and the like. An example of the program instruction includes not only a machine language created by a compiler but also a high-level language executable by a computer by using an interpreter or the like. The aforementioned hardware device may be configured to operate as one or more software modules to perform the operation of various example embodiments of the present disclosure, and the other way around is also possible.

The module or programming module according to various example embodiments of the present disclosure may further include at least one or more constitutional elements among the aforementioned constitutional elements, or may omit some of them, or may further include additional other constitutional elements. Operations performed by a module, programming module, or other constitutional elements of the present disclosure may be executed in a sequential, parallel, repetitive, or heuristic manner. In addition, some of the operations may be executed in a different order or may be omitted, or other operations may be added.

While various example embodiments of the present disclosure have been shown and described with reference to certain embodiments thereof, it will be understood by those skilled in the art that various changes in form and details may be made therein without departing from the example embodiments of the present disclosure as defined by the appended claims. Therefore, the scope of the various example embodiments of the present disclosure is defined not by the detailed description of the various example embodiments of the present disclosure but by the appended claims, and all differences within the scope will be construed as being included in the various example embodiments of the present disclosure.

What is claimed is:

1. An electronic device comprising:
a 1^{st} antenna configured to transmit/receive a first signal using at least one of a 1^{st} communication network or a 2^{nd} communication network;
a 2^{nd} antenna configured to receive a second signal using at least one of the 1^{st} communication network or the 2^{nd} communication network;
a 1^{st} Front End Unit (FEU) configured to split the first signal into a first plurality of frequency band signals for the 1^{st} communication network or the 2^{nd} communication network;
a 2^{nd} FEU configured to split the second signal into a second plurality of frequency band signals for the 1^{st} communication network or the 2^{nd} communication network;
a 1^{st} Radio Frequency Integrated Chip (RFIC) configured to process a 1^{st} frequency band signal of at least one of the first plurality of frequency band signals or the second plurality of frequency band signals provided from the 1^{st} FEU or the 2^{nd} FEU for the 2^{nd} communication network; and
a 2^{nd} RFIC configured to process a 2^{nd} frequency band signal of at least one of the first plurality of frequency band signals and the second plurality of frequency band signals provided from the 1^{st} FEU or the 2^{nd} FEU for the 2^{nd} communication network,
wherein, when a 3^{rd} frequency band signal is identified for the 1^{st} communication network, the 1^{st} RFIC is configured to process the 3^{rd} frequency band signal of the first plurality of frequency band signals provided from the 1^{st} FEU and process the 1^{st} frequency band signal provided from the 2^{nd} FEU.

2. The electronic device of claim 1, wherein the 1^{st} RFIC is configured to route to the 1^{st} FEU a signal for at least one of the 1^{st} communication network or the 2^{nd} communication network, and route to the 1^{st} FEU the 1^{st} frequency band signal of the 2^{nd} communication network when the signal for at least one of the 1^{st} communication network is detected.

3. The electronic device of claim 2, wherein the 1^{st} FEU comprises at least one power amplification module configured to amplify power of a signal provided from the 1^{st} RFIC according to a characteristic of a communication network for transmitting the signal provided from the 1^{st} RFIC.

4. The electronic device of claim 1, wherein the 1^{st} FEU further comprises:
a signal split module for splitting the first or second signal of the 1^{st} or 2^{nd} communication network received through the 1^{st} antenna into a low frequency band signal and a high frequency band signal;
a 1^{st} quadplexer for splitting the low frequency band signal into the 3^{rd} frequency band signal of the 1^{st} communication network and the 1^{st} frequency band signal of the 2^{nd} communication network; and
a 2^{nd} quadplexer for splitting the high frequency band signal into a 4^{th} frequency band signal of the 1^{st} communication network and the 2^{nd} frequency band signal of the 2^{nd} communication network.

5. The electronic device of claim 4,
wherein the 1^{st} quadplexer comprises a plurality of filters for filtering different frequency band signals to split the different frequency band signals into the 3^{rd} frequency band signal of the 1^{st} communication network and the 1^{st} frequency band signal of the 2^{nd} communication network by using the respective filters, and
wherein the 2^{nd} quadplexer comprises a plurality of filters for filtering different frequency band signals to split the different frequency band signals into the 4^{th} frequency band signal of the 1^{st} communication network and the 2^{nd} frequency band signal of the 2^{nd} communication network by using the respective filters.

6. The electronic device of claim 1, wherein the 2^{nd} FEU comprises:
a signal split module for splitting a signal received through the 2^{nd} antenna into at least one of a plurality of frequency band signals for the 1^{st} communication network, or a plurality of frequency band signals for the 2^{nd} communication network; and
at least one Low Noise Amplifier (LNA) module configured to perform low frequency amplification on respective frequency band signals split by the signal split module.

7. The electronic device of claim 1, wherein the 1^{st} communication network comprises at least one of Code Division Multiple Access (CDMA), Wideband CDMA (WCDMA), Time Division-Synchronous CDMA (TD-SCDMA), Evolution-Data Optimized (EV-DO), or Global System for Mobile communications (GSM).

8. The electronic device of claim 1, wherein the 2^{nd} communication network comprises at least one of Long Term Evolution (LTE) or mobile WiMAX.

9. The electronic device of claim 1, wherein the 2^{nd} RFIC is further configured to process a 4^{th} frequency band signal provided from the 1^{st} FEU at a time of identifying the 4^{th} frequency band signal of the 1^{st} communication network, and process the 2^{nd} frequency band signal provided from the 2^{nd} FEU.

10. A method of operating an electronic device in communication with a 1^{st} and 2^{nd} communication network, the method comprising:
processing signals for different frequency bands of the 2^{nd} communication network through a plurality of Radio Frequency Integrated chips (RFICs); and
identifying whether a signal of the 1^{st} communication network is received through a 1^{st} antenna in a 1^{st} RFIC of a plurality of RFICs when detecting the signal of the 1^{st} communication network, and processing a signal of the 2^{nd} communication network received through the 2^{nd} communication network,
wherein the 1^{st} antenna transmits/receives a signal utilizing at least one of the 1^{st} communication network or the 2^{nd} communication network, and
wherein a 2^{nd} antenna of the electronic device receives a signal utilizing at least one of the 1^{st} communication network or the 2^{nd} communication network.

11. The method of claim 10, further comprising transmitting the signal of the 2^{nd} communication network in the 1^{st} RFIC when detecting the signal of the 1^{st} communication network.

12. The method of claim 10, wherein the 1^{st} communication network comprises at least one of Code Division Multiple Access (CDMA), Wideband CDMA (WCDMA), Time Division-Synchronous CDMA (TD-SCDMA), Evolution-Data Optimized (EV-DO), or Global System for Mobile communications (GSM).

13. The method of claim 10, wherein the 2^{nd} communication network comprises at least one of Long Term Evolution (LTE) or mobile WiMAX.

14. The method of claim 10, wherein identifying whether the signal of the 1^{st} communication network is received further comprises identifying whether a paging signal for a 1^{st} frequency band of the 1^{st} communication network is received through the 1^{st} antenna in the 1^{st} RFIC when detecting the signal of the 1^{st} communication network.

15. The method of claim 14, further comprising detecting whether a signal for a 2^{nd} frequency band is received through the 1^{st} antenna in a 2^{nd} RFIC of the plurality of RFICs when detecting the signal for the 2^{nd} frequency band of the 1^{st} communication network, and processing the signal of the 2^{nd} communication network received through the 2^{nd} antenna.

16. The method of claim 15, further comprising transmitting the signal of the 2^{nd} communication network to the 1^{st} antenna in the 1^{st} RFIC when detecting the signal for the 2^{nd} frequency band of the 1^{st} communication network.

17. A non-transitory computer readable recording medium storing program instructions, the program instructions executable by a processor of an electronic device to:
process signals for different frequency bands of a 2^{nd} communication network through a plurality of Radio Frequency Integrated Chips (RFICs) in the electronic device, the electronic device comprising a 1^{st} antenna for transmitting/receiving a signal utilizing at least one of a 1^{st} communication network or the 2^{nd} communication network, and a 2^{nd} antenna for receiving a signal utilizing at least one of the 1^{st} communication network or the 2^{nd} communication network; and
when the signal is received through the 1^{st} communication network, identify whether the signal of the 1^{st} communication network is received through the 1^{st} antenna in the 1^{st} RFIC of a plurality of RFICs, and process a signal of the 2^{nd} communication network received through the 2^{nd} antenna.
